(19) United States
(12) Patent Application Publication
(10) Pub. No.: US 2005/0102574 A1
(43) Pub. Date: May 12, 2005

(54) Apparatus and method for performing boundary scans using fixed and variable signal groups

(76) Inventors: Lee A. Larson, Katy, TX (US); Henry R. Hoar, Missouri City, TX (US); Huimin Xu, Missouri City, TX (US)

Correspondence Address: TEXAS INSTRUMENTS INCORPORATED, P O BOX 655474, M/S 3999, DALLAS, TX, 75265, US

(21) Appl. No.: 10/942,396

(22) Filed: Sep. 16, 2004

Related U.S. Application Data
(60) Provisional application No. 60/517,457, filed on Nov. 5, 2003.

(51) Int. Cl. G06F 11/00

(52) U.S. Cl. 714/30

(57) ABSTRACT

In a JTAG test and debug environment, the signal groups may have a variable length, a fixed length or a combination of both fixed and variable signal groups to be transferred to the target processor. To implement the three types of data transfers, the storage unit associated with the scan control unit includes two types of storage locations, fixed signal length storage locations and variable length storage locations. The software can select the mode of data transfer and this selection is provided to the scan controller by a command.

This application claims priority under 35 USC §119(e)(1) of Provisional Application No. 60/517,457 (TI-36184P) filed Nov. 5, 2003.

### 1. FIELD OF THE INVENTION

This invention relates generally to the use of emulation units to perform test and debugging operations on a digital signal processor target system and, more particularly, to providing a method for optimizing JTAG (Joint Test Action Group) transfers between a test and debug unit and target processor. The present invention improves the performance of the test and debug unit in boundary scans.

### 2. BACKGROUND OF THE INVENTION

In the past, test and debug procedures on digital signal processors was done using a scan control unit that converts parallel information from a test and debug unit into a serial data stream. The data values to be scanned out needed to be loaded each time a scan was executed, unless all of the data values were identical.

In a high performance scan controller, the number of times the test and debug unit must load the registers in the scan control unit can become a limiting factor of the performance of the testing procedure. This problem is compounded by the increasing speed of the test clock, which is the speed at which data is serialized and sent to the target processor.

There are two efficiency factors that govern the performance of a test and debug system. These factors are the inherent efficiency of the target processor itself, and the efficiency of the scan control unit. The efficiency of the target processor relates to how many bits of information and control signals must be sent to the target processing unit to perform an operation such as a single step operation, memory access operation, or register access operation. This factor is ignored by this invention since the digital signal processor efficiency cannot be altered by the scan control unit implementation.

The efficiency of the scan control unit relates to how many bits must be loaded into the scan control unit to cause it to send out the required number of bits for the digital signal processor to perform an operation with no dead time between operations. For certain types of operations, the information to be scanned out consists of a fixed value, possibly an opcode, and a variable value, possibly address or data value.

If a scan control unit has a 16-bit interface with the test and debug unit, and the test clock rate is 32 MHz, the scan control unit must be provided with a data value every 500 ns in order to run at 100% efficiency. In addition, the test and debug unit must load control information into the scan control unit to control the scans and the target processor JTAG interface, as well as access status from the scan control unit related to the scan operations. If the scan control unit access time and test and debug unit memory access times are on the order of 100 ns, then 40% of the bus bandwidth is consumed just by data transfers to the target signal processor. If the target processor is also returning information, then data transfers will be consuming 80% of the bus bandwidth. If the test and debug unit must access the scan controller to determine if a data value can be loaded or read, the remaining 20% of the bus bandwidth is used up, leaving no time for loading control information into the scan controller, or execution of instructions by the test and debug unit.

These limitations can be addressed in 3 ways, widen the data path between the test and debug unit and the scan control unit and memory, reduce the access time, and reduce the number of times the scan control unit must be accessed. Widening the data path requires additional pins on the scan controller device, the debug unit and the memory, and may not always be possible. Reducing the access time of the scan control unit or memory might be possible, but is limited by the particular implementation of both. Reducing the number of accesses of the scan control unit provides a means of improving the efficiency, which can be applied in conjunction with the other two techniques.

Referring to FIG. 1, a block diagram of a test and debug system capable of advantageously using the present invention is shown. The test and debug system includes a user interface 5, a test and debug unit 10, and a target processor 15. The user interface 5 includes the apparatus that permits a user to interact with, and control the testing of, the target processing unit 15. The user interface 5 can include display apparatus, input apparatus such as a keyboard, etc. for initiating test and debug procedures and for receiving the results of these procedures. The user interface 5 is coupled to the test and debug unit 10 through interface unit 101. The interface unit 101 exchanges signals with the processing unit 102 of the test and debug unit 10. The processing unit 102 applies signals to and receives signals from the scan control unit 103. The scan control unit 103 includes a local processor 1031, and memory unit out 1032 for exchanging signals with the local processor 1031, a memory unit in 1035 for storing signals from the target processing unit 15, a shift register out 1034 and a shift register in 1033, the shift registers 1033 and 1034 transferring data in and out of the test and debug unit 10 under control of the local processor 1031. For purposes of the present invention, the processing unit 102 provides commands to the scan control unit 103 and supplies the contents of the memory unit 1032. The target processing unit 15 includes a test access port 151, a shift register 152, an instruction register 153, a data register 154, a mini-status register 155, and a data register 156. The test access port 151 is a state machine responsive to test mode select (TMS) signals from the processing unit 102 for controlling the JTAG apparatus in the target processing unit 15. The shift register 152 receives signals from the shift register out 1034 and transfers signals to the shift register in 1033. The shift register 152 applies signals to the instruction register 153 and with the data register 154 and receives signals from the mini-status register 155 and the data register 156.

Referring to FIG. 2, a portion of the contents of the memory unit out 1032, according to the prior art, is illustrated. In particular, the memory unit o8ut 1032 includes a command parameter section 1032A. Examples of the parameters included in the command parameter section are parameters defining a JTAG scan length and parameters defining JTAG end states. A command from the processing unit 102 will include reference to these parameters and these parameters will be accessed and appropriate control signals applied to the test access port 151 by the local processor.

Referring to FIG. 3, the execution of a command is illustrated. When command A is issued, the command active signal is activated. The command active signal allows the go to shift state function, the send/receive function, and the go to end state to be executed by the scan control unit 103. When the command active signal is no longer active, then a next command B can be executed. If a command C is issued while the target processor is still executing command A, command C will fail and be must retried.

In the past, configurations employing a JTAG emulation unit to test and debug a digital signal processor have had to issue a transaction, such as a read memory command, and then issue additional commands to retrieve the data or to determine if the original transaction was successful. The delay between the commands was usually sufficient to allow the target system the opportunity to complete the transaction. Transactions are usually initiated when the JTAG state (machine) transitions through “Update IR” to “Idle” or Pause. (The state diagram for the JTAG test and debug procedure is shown in FIG. 4. The four stable, non-shift JTAG states are indicated in this Figure as states 41, 42, 43 and 44.) New transactions are initiated by entering the “Scan” state. When the target system does not respond in a timely manner, the transaction will fail, and the test and debug unit 10 must retry the transaction. The transaction retries impact the performance of the test and debug configuration and, in the situation involving large data transfers with many retries, can result in a significant degradation of the configuration performance.

A need has been felt for apparatus and an associated method having the feature of being able to increase the rate of transfer of information from a test and debug unit to a target processing unit. It would be another feature of the apparatus and associated method to reduce the number of accesses of the test and debug processing unit with the scan control unit. It would be yet another feature of the apparatus and associated method to provide for fixed and for variable transfer of signal groups by the JTAG apparatus. It would be a still further feature of the present invention to provide for a mixed fixed/variable transfer of signal groups in a JTAG system. It is a more particular feature of the present invention to provide one group of storage locations for fixed length signal groups to be transferred to the target processing unit. It is another more particular feature of the present invention to provide a buffer storage unit for the storage of variable length storage groups in the scan controller prior to the transfer to the test processor.

### SUMMARY OF THE INVENTION

The aforementioned features are accomplished, according to the present invention, by providing a storage unit accessible to the scan controller of a JTAG test and debug unit. The storage unit includes storage locations for storing fixed length signal groups and storage locations (first-in first-out or FIFO memory) for storing variable-length signal groups. The scan control unit, in response to command signals from the test and debug processing unit, can either apply the fixed-length signal groups to the shift register out, apply the variable-length signal groups to the scan register out, or can apply a combination of fixed- and variable-length signal groups to the shift register out.

Other features and advantages of present invention will be more clearly understood upon reading of the following description and the accompanying drawings and the claims.

### BRIEF DESCRIPTION OF THE DRAWINGS

FIG. 1 is a block diagram of prior art test and debug apparatus capable of advantageously using the present invention.

FIG. 2 illustrates the contents of the scan controller memory unit according to the prior art.

FIG. 3 illustrates the execution of a command in the JTAG test and debug environment according to the prior art.

FIG. 4 is a JTAG state diagram according to the prior art.

FIG. 5 illustrates the structure of the memory unit out of the scan control unit according to the present invention.

FIG. 6 illustrates the structure of a command applied to the scan control unit to provide the memory unit out access according to the present invention.

### DESCRIPTION OF THE PREFERRED EMBODIMENT

### 1. DETAILED DESCRIPTION OF THE FIGURES

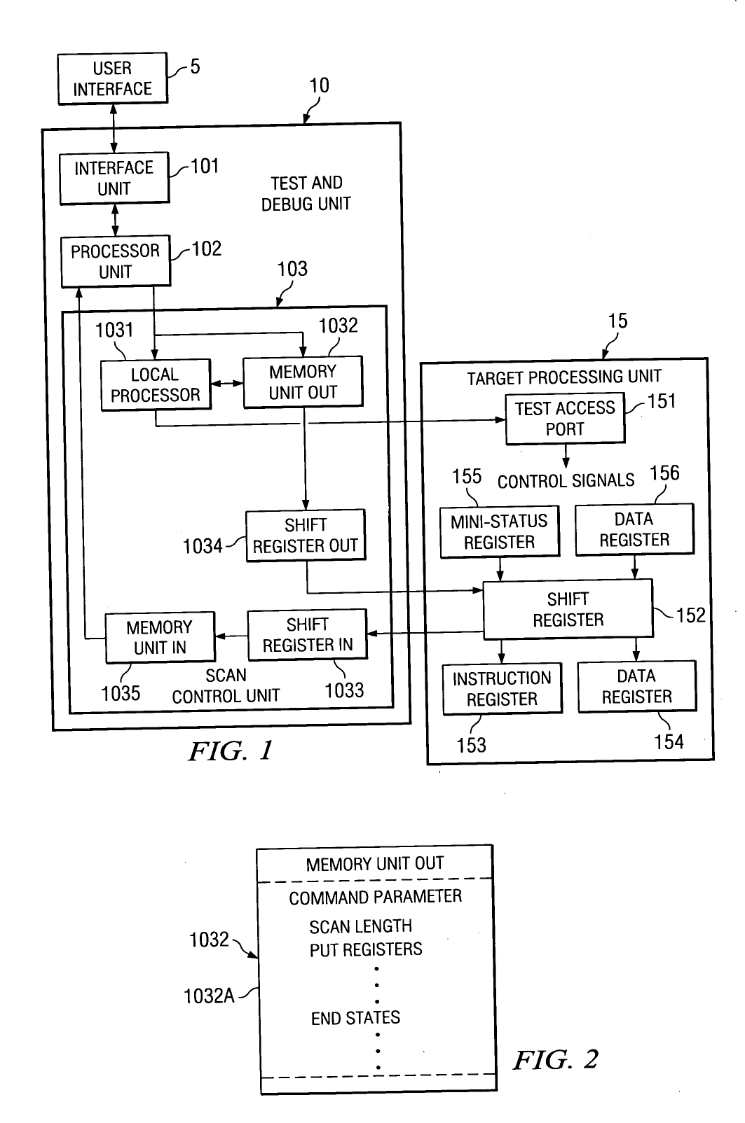

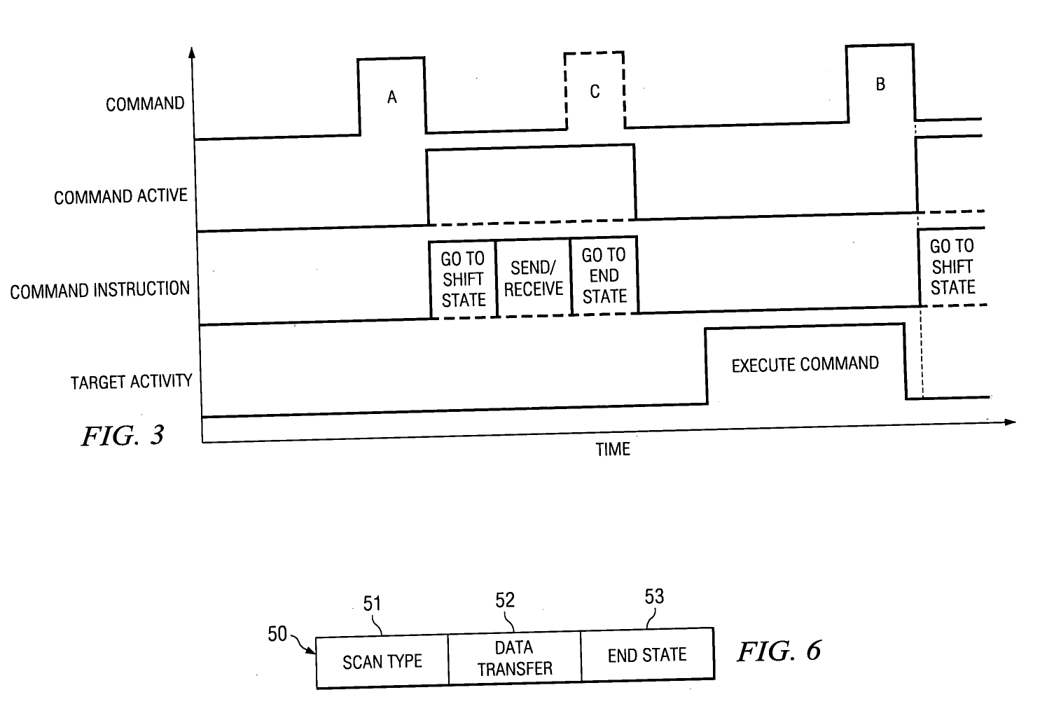

FIGS. 1, 2, 3, and 4 have been described with respect to the related art.

Referring next to FIG. 5, the structure of the memory unit out 1032 according to present invention is shown. The memory unit out 1032 includes command parameter storage locations 1032A. The command parameter storage locations 1032A are storage locations identifying scan length and end states, states that must be communicated to the target processing unit. In storage locations 1032B, the fixed length signal groups to be transferred to the target processing unit. In the storage locations 1032C, the signal groups are stored that have a variable length. In the preferred embodiment, these storage locations are implemented by a FIFO memory unit.

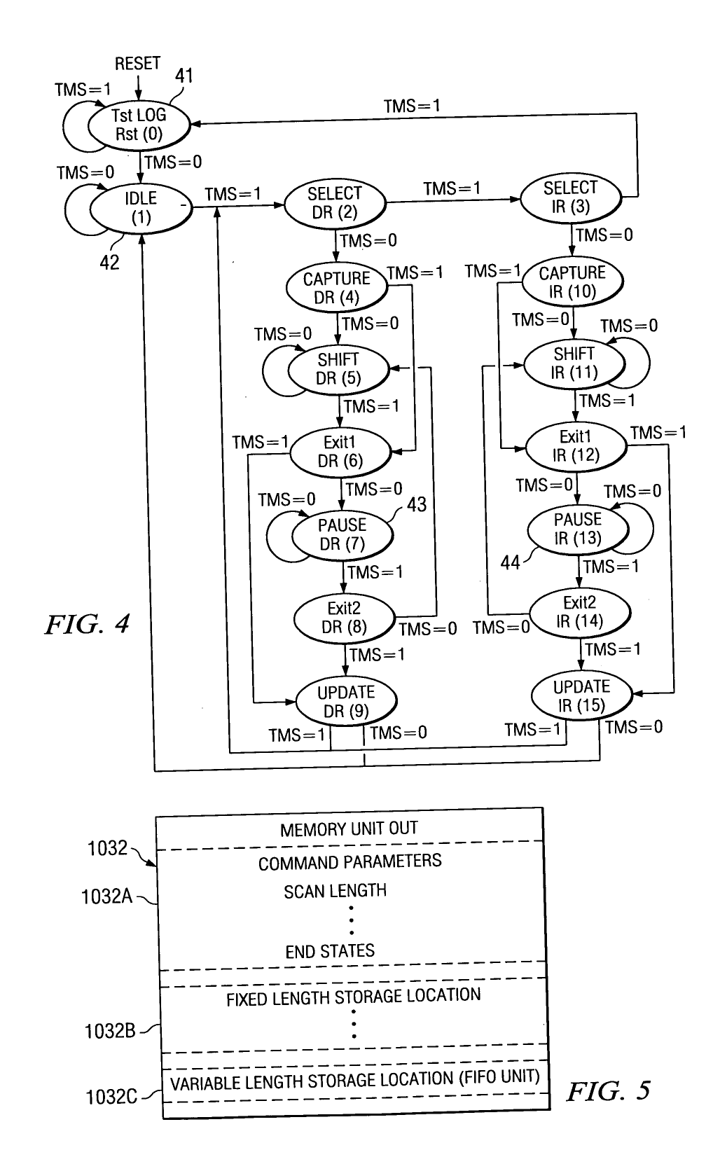

Referring to FIG. 6, the structure of a command applied to the scan control unit 103 from the test and debug processing unit is shown. The command includes, for purposes of this discussion, three parameters. In the preferred embodiment, the parameters represent storage locations in the memory unit out 1032. The local processor 1031 will retrieve the fields at the indicated storage locations and implement the data transfers in an appropriate manner. The scan length parameter 61 and the end state parameter 63 designate storage locations that store JTAG states illustrated in FIG. 4. These JTAG states are communicated by the scan control unit 103 to the target processing unit 15. The data transfer parameter 62 designates whether the data transfer to the target processing unit 15 is a fixed mode transfer, a variable mode transfer, or a mixed mode transfer. The data transfer parameter 62 causes the scan control unit to implement the appropriate transfer mode at the designated locations.

### 2. OPERATION OF THE PREFERRED EMBODIMENT

The invention allows the software to select the source of a data scan. The software can select the registers, the buffers or a combination of both. Using the mixed mode scan allows the software to load the fixed portion of data into the registers and then repeatedly issue the same scan command, only supplying the variable portion of the data on all of the scans after the first scan.

Examples of mixed mode scans include a fixed opcode, such as read memory, and a variable address. When the scan is repeated, the processor simply provides a series of address values. Another example is a memory fill operation. In this case, a fixed opcode for memory write is used, with a variable write address, and either fixed or variable fill data depending upon the type of memory fill. Control bits in the scan command register select the mixed mode scan.

The scan controller designed using this invention implements storage unit with two sets of four 16-bit data registers used to supply the fixed data values for two separate, combinable scans, and a single 16-bit wide FIFO to supply the variable portion of the data. In normal scan mode, two variable data values (32-bits) are scanned out followed by an opcode value from the third register. In streaming scan mode, the order is reversed, a 16-bit opcode value is scanned out, followed by two variable data values (32-bits).

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

1. A test and debug system for testing a target processor, the system comprising:
data transfer apparatus in the target processor to receiving data and for transferring data;
a test access port in the target processor responsive to control signals, the control signals determining the state of the test and debug apparatus in the target processor; and
a scan control unit, the scan control unit including:
a processor responsive to commands for generating the control signals;
at least one register responsive to signals from the processor for exchanging data with the data transfer apparatus; and
a storage unit having at least one fixed length location and at least one variable length storage location.

2. The system as recited in claim 1 wherein the scan control unit can transfer to the target processor fixed length signal groups, variable length signal groups, or signal groups having both fixed signal group and variable signal group components.

3. The system as recited in claim 2 wherein, in response to a command from the test and debug processing unit, mode of signal group transfer identified by parameters of the command is implemented.

4. The system as recited in claim 3 wherein the signal group is boundary scan signal group.

5. In a JTAG test and debug system, a method for transferring signal groups under the control of a scan control unit, the method comprising:
storing the signal group in at least one of a fixed signal group length register and a variable length signal group storage locations; and
in response to command, transferring the signal group to a target processor in a fixed signal group mode, a variable signal group mode or mixed signal group mode.

6. The method as recited in claim 5 wherein the signal group is a boundary scan signal group.

7. In a test and debug unit, a scan control unit comprising:
a local processor responsive to at least one command;
a shift register out, the shift register out shifting signals out of the scan control unit. and
a storage unit having fixed signal group length storage locations and at least one variable signal group storage location.

8. The scan control unit as recited in claim 7 wherein the local processor, in response to a parameter in a command, shifts the stored signal groups in a fixed mode, in a variable mode, or in both modes.

9. The scan control unit as recited in claim 8 wherein the signal group is a boundary scan signal group.
